(19) United States
(12) Patent Application Publication
(10) Pub. No.: US 2010/0070761 A1
(43) Pub. Date: Mar. 18, 2010

(54) RELIABLE AUTHENTICATION OF MESSAGE SENDER'S IDENTITY

(75) Inventors: Christophe Gustave, Ottawa (CA); Vinod Choyi, Ottawa (CA); Shu-Lin Chen, Kanata (CA)

Correspondence Address: FAY SHARPE/LUCENT, 1228 Euclid Avenue, 5th Floor, The Halle Building, Cleveland, OH, 44115-1843, US

(73) Assignee: Alcatel-Lucent, Paris (FR)

(21) Appl. No.: 12/212,368

(22) Filed: Sep. 17, 2008

(51) Int. Cl. H04L 9/06

(52) U.S. Cl. 713/156; 380/277

(57) ABSTRACT

A method is provided in a telecommunications network for authenticating a sender (10) of a message to a recipient of the message. The method includes: registering the sender (10) with a trusted certificate authority (CA) (20), the registering including providing the CA (20) with (i) identification information identifying the sender (10) and (ii) a public key (12) of the sender (10); creating an authentication certificate (30) including the sender's identification information and the sender's public key (12); signing the certificate (30) with a private key (28) of the CA (20); provisioning a message sending device (52) of the sender (10) with the certificate (30) that was signed with the private key (28) of the CA (20); provisioning a message receiving device (40) of the recipient with a public key (24) of the CA (20), the CA's public key (24) being a corresponding counterpart to the CA's private key (28); generating a signature with a private key (14) of the sender (10), the sender's private key (14) being a corresponding counterpart for the sender's public key (12); sending a message from sender's message sending device (52), the message including the certificate (30) and the signature; retrieving the message with the recipient's message receiving device (40); using the CA's public key (24) with which the recipient's receiving device (40) was provisioned to obtain the sender's public key (12) from the certificate (30) received in the retrieved message; and, using the sender's public key (12) obtained from the certificate (30) received in the retrieved message to verify the signature generated with the sender's private key (14).

### FIELD

The present inventive subject matter relates generally to the telecommunication arts. Particular application is found in conjunction with authenticating the identity of a message sender to a message recipient, e.g., when using a telecommunications message service such as Short Message Service (SMS), Multimedia Messaging Service (MMS), Enhanced Messaging Service (EMS), etc. Accordingly, the specification makes particular reference thereto. However, it is to be appreciated that aspects of the present inventive subject matter may also be amenable to other like telecommunications messaging services and/or applications.

### BACKGROUND

SMS is a popular service used to exchange messages over a telecommunications network. Additionally, extensions of SMS are also known, such as MMS, EMS and the like, which are commonly used to exchange messages including multimedia content or other enhanced message content. However, for simplicity and/or clarity herein, the present specification may at times refer to SMS only. Nevertheless, when referring to SMS herein, it is to be understood that such reference is generally intended to encompass when appropriate the aforementioned extensions as well.

Various types of customer-premise equipment (CPE) and/or end-user devices are commonly equipped or otherwise provisioned to send and/or receive SMS messages. These devices are generally referred to herein as SMS-enabled devices or SMS-enabled CPE. Examples include, wireless or mobile telephones, smartphones, wireless personal digital assistants (PDAs) or other like handheld devices, laptop and/or desktop computers, etc.

One drawback that can be encountered with SMS messaging is that a message recipient may not positively know the origin of a received message and/or the identity of the message sender. For example, an unscrupulous message sender may impersonate someone else in an attempt to trick or otherwise deceive a message recipient into revealing sensitive information (e.g., a username, a password, financial account information, etc.) that the recipient would not otherwise divulge had the recipient known the true identity of the message sender. Such attacks, commonly known as phishing, are particularly harmful scams that may be perpetrated via SMS. Yet, there has been heretofore no widely accepted and/or sufficiently robust solution to combat these types of SMS phishing attacks.

U.S. Patent Application Publication No. 2003/0236981 to Marmigere, et al. (hereinafter referred to merely as “Marmigere”) discloses a manner for authenticating SMS messages using a digital signature computed with a device's IMEI (International Mobile Equipment Identity) as a key. However, the approach proposed in Marmigere has limitations. For example, one limitation to the Marmigere approach is clearly apparent since there is no notion of asserted identity that could allow the recipient of such a message to determine whether they can trust the content and/or origin of the SMS message. Rather, the IMEI is tied to the mobile device, and does not identify a subscriber. Also, SMS messages can be sent from computers and/or other like devices which may not have an IMEI. Accordingly, the Marmigere solution would not adequately provide the desired authentication in such cases. Moreover, in many instances, multiple different end-users may employ the same mobile telephone or other device to send SMS messages (e.g., organizations or families may employ a mobile telephone or other like device that is shared by multiple users). In accordance with the Marmigere solution, the IMEI-based signature would incorrectly identify the various different users as being the same insomuch as they would be using the same mobile device.

Also known are mechanisms for servers to authenticate message senders. For example, a server supporting the supply of SMS services to a message sender may authenticate the sender's identity before providing them access to the service, e.g., to ensure that the sender is in fact a subscriber to the service or is otherwise entitled to use the service. However, such authentication does not generally translate into end-to-end authentication which assures the message recipient of the true identity of the message sender. That is to say, even if the server authenticates the sender of the message for purposes of granting the sender access to the service, this authentication does not generally assure the message recipient that the sender is who they purport to be. In fact, server to sender authentication is not generally sufficient and may not even be communicated to the recipient, e.g., when the sender and the recipient belong to different service providers. That is to say, in this context, the server of the message recipient generally cannot authenticate the message sender when the message sender belongs to a different service provider.

Accordingly, a new and improved system and/or method is disclosed that addresses the above-referenced problems and others.

### SUMMARY

In accordance with one embodiment, a method is provided in a telecommunications network for authenticating a sender of a message to a recipient of the message. The method includes: registering the sender with a trusted certificate authority (CA), the registering including providing the CA with (i) identification information identifying the sender and (ii) a public key of the sender; creating an authentication certificate including the sender's identification information and the sender's public key; signing the certificate with a private key of the CA; provisioning a message sending device of the sender with the certificate that was signed with the private key of the CA; provisioning a message receiving device of the recipient with a public key of the CA, the CA's public key being a corresponding counterpart to the CA's private key; generating a signature with a private key of the sender, the sender's private key being a corresponding counterpart for the sender's public key; sending a message from sender's message sending device, the message including the certificate and the signature; retrieving the message with the recipient's message receiving device; using the CA's public key with which the recipient's receiving device was provisioned to obtain the sender's public key from the certificate received in the retrieved message; and, using the sender's public key obtained from the certificate received in the retrieved message to verify the signature generated with the sender's private key.

In accordance with another embodiment, a method is provided in a telecommunications network for authenticating a sender of a message to a recipient of the message. The method includes: registering the sender with a trusted certificate authority (CA), the registering including providing the CA with (i) identification information identifying the sender and (ii) a public key of the sender; creating an authentication certificate including the sender's identification information and the sender's public key; signing the certificate with a private key of the CA; provisioning a message receiving device of the recipient with a public key of the CA, the CA's public key being a corresponding counterpart to the CA's private key; generating a signature with a private key of the sender, the sender's private key being a corresponding counterpart for the sender's public key; sending a message from a message sending device of the sender, the message including the signature and a pointer that indicates a location where the certificate is stored; retrieving the message with the recipient's message receiving device; fetching the certificate with the recipient's message receiving device from the location indicated by the pointer; using the CA's public key with which the recipient's receiving device was provisioned to obtain the sender's public key from the certificate received in the retrieved message; and, using the sender's public key obtained from the certificate received in the retrieved message to verify the signature generated with the sender's private key.

In accordance with yet another embodiment, a system is provided in a telecommunications network, for authenticating a sender of a message to a recipient of the message. The system includes: registering means for registering the sender with a trusted certificate authority (CA), the registering including providing the CA with (i) identification information identifying the sender and (ii) a public key of the sender; certificate creation means for creating an authentication certificate including the sender's identification information and the sender's public key, the certificate being signed with a private key of the CA; message sending means for sending a message from the sender, the message sending means being provisioned with the certificate that was signed with the private key of the CA and signature generating means for generating a signature with a private key of the sender, the sender's private key being a corresponding counterpart for the sender's public key, wherein a message sent from sender's message sending device includes the certificate and the signature; and, message receiving means for retrieving a message sent to the recipient from the sender, the message receiving means being provisioned with a public key of the CA, the CA's public key being a corresponding counterpart to the CA's private key. Suitably, the message receiving means: (i) uses the CA's public key with which it is provisioned to obtain the sender's public key from the certificate received in the retrieved message, and (ii) uses the sender's public key obtained from the certificate received in the retrieved message to verify the signature generated with the sender's private key.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter disclosed herein may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is diagrammatic illustration showing an exemplary infrastructure and/or process for the registration of SMS message senders in accordance with aspects of the present inventive subject matter.

FIG. 2 is diagrammatic illustration showing an exemplary infrastructure and/or process for provisioning SMS-enabled recipient devices with the root certificates and/or public keys of certificate authorities in accordance with aspects of the present inventive subject matter.

FIG. 3 is diagrammatic illustration showing an exemplary infrastructure and/or process for executing SMS authentication in accordance with aspects of the present inventive subject matter.

FIG. 4 is a post and rail diagram showing an exemplary message exchange and/or process for authenticating an SMS message sender's identity to a message recipient in accordance with one embodiment of the present inventive subject matter.

FIG. 5 is a post and rail diagram showing another exemplary message exchange and/or process for authenticating an SMS message sender's identity to a message recipient in accordance with another embodiment of the present inventive subject matter.

### DETAILED DESCRIPTION OF PREFERRED EMBODIMENTS

For clarity and simplicity, the present specification shall refer to structural and/or functional elements, entities and/or facilities, relevant standards, protocols and/or services, and other components that are commonly known in the art without further detailed explanation as to their configuration or operation except to the extent they have been modified or altered in accordance with and/or to accommodate the preferred embodiment(s) presented herein.

In general, the present specification is directed to an authentication solution for SMS which is an extension and/or alternate application of the authentication framework disclosed in U.S. Patent Application Publication No. 2008/0181379, incorporated by reference herein in its entirety. More specifically, the present specification describes a method and/or system that uses public key cryptography techniques and a set of certificate registries to achieve strong end-to-end SMS authentication which positively identifies the sender of a particular SMS message to the message recipient.

In general terms, an SMS-enabled CPE or other like recipient device is initially provisioned with a list of trusted certificate authorities, e.g., associated with industries, communities, special interests or other groups of relevance to the end-user of the message receiving device. Upon sending an SMS message, the CPE or other sending device loads an authentication certificate (e.g., such as an X.509 certificate), produces a hash of the message to be sent and finally produces a cryptographic signature based on this hash, the private key associated to the certificate and extra information (e.g., such as a timestamp) to guard against replay types of attacks. At the end of this process the signature and the timestamp are added to the SMS message. Suitably, there are two ways to proceed with end-user certificate delivery to the SMS-targeted CPE: (i) add the certificate with the message to be sent (this is the simplest way to transfer the certificate to the targeted recipient); and (ii) add a reference ID to the certificate into the message to be delivered (in which case the targeted CPE will have to fetch the certificate based on the reference ID at the appropriate time, i.e., at the time of message authentication and/or sender identification).

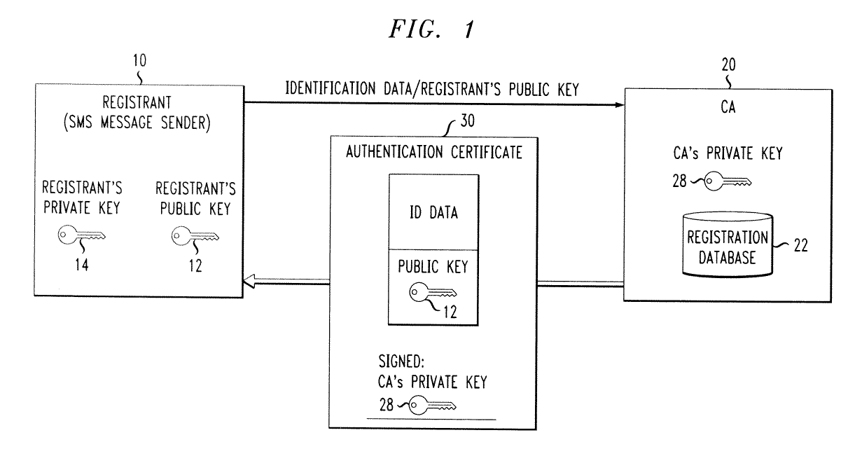

FIG. 1 is a schematic diagram of an exemplary registration infrastructure and/or process for the registration of SMS message senders in accordance with aspects of the present inventive subject matter. In the illustrated example, there is shown a single registrant 10 (i.e., an SMS message sender) registering with a single registry and/or certificate authority (CA) 20. In practice, however, a given registrant may selectively register with any number (i.e., one or more) of separately deployed and/or otherwise established registries or CAs (e.g., arranged and/or provisioned similarly to the CA 20), and each such registry and/or CA may register any number (i.e., one or more) of applying registrants (e.g., arranged and/or provisioned similarly to the registrant 10). For example, in practice a plurality of different registries and/or CAs may optionally be deployed or otherwise established to serve different groups and/or types of registrants and/or end-users. That is to say, a first registry and/or CA may be aimed, e.g., at serving an indiscriminate group of registrants and/or end-users, while a second registry and/or CA may be aimed, e.g., at serving some particular group or type of registrants and/or end-users (such as enterprises or end-users associated with a particular industry or trade or other special interest), and yet a third registry and/or CA may be aimed, e.g., at serving yet another particular group or type of registrants and/or end-users (such as those in a particular geographical or geopolitical region). Nevertheless, while each registry and/or CA suitably serves a predetermined subscriber group, region and/or a predefined interest group, it is to be appreciated that a region or group served by one registry and/or CA may overlap a region or group served by another, and two or more registries and/or CAs may serve the same region or group.

As a further example, one registry and/or CA may be operationally operated by a service provider that wishes to provide authenticated SMS to any company, public or government organization, or other registrant 10 who wishes to provide authenticated SMS message sender identification to message recipients. Yet another registry and/or CA may be optionally operated by an interest group, such as the Canadian Bankers Association®, which maintains the registry and/or CA to provide authenticated SMS registry for its bank members. As yet a further example, another registry and/or CA is optionally associated with a geographical or political region, such as New York State; the Province of Ontario; the City or Toronto; the greater Chicago area; etc. and is operated by a corresponding government agency or other official entity.

In any event, suitably, the SMS message sender or registrant 10 registers their name, identification information and/or other like ID with the selected CA 20 so as to be able to authenticate themselves as message originators or senders (e.g., by providing their authenticated name, identification information and/or other like ID) to message recipients that subscribe to the particular registry or CA 20 or that are otherwise provisioned with the public key of the corresponding CA 20. Accordingly, as illustrated, the CA 20 suitably maintains a database 22 of names, identification information and/or other like IDs for registered SMS message senders, such as the registrant 10.

Suitably, the CA 20 may be any public or private organization interested in providing an authenticated registry. Optionally, a higher-level authority does not have to sanction the CA 20. Rather, end-users can determine if the given registry and/or CA 20 is trustworthy, and subscribe only if it is determined to be trustworthy. In one embodiment of the invention, the only responsibility borne by the CA 20 is to ensure proof of identity of any registrant, and ensure that it does not register any duplicate name, identification information or other ID for different registrants. In this embodiment, the registry (which consists of the database (DB) 22 and the CA 20) can be freely inspected by the public and it is the responsibility of registrants and/or other interested parties to police the registries in order to ensure that a confusingly similar or misleading identity is not registered by another registrant.

In any event, when the registrant 10 is registered, the CA 20 issues an authentication certificate 30. The certificate 30 certifies that the registered SMS message sender's identity is bound to the registrant's public key 12 (which is in turn implicitly paired with the registrant's private key 14). Suitably, the authentication certificate 30 provided to the registrant 10 by the registry or CA 20 can optionally conform to any known authentication system, and each registry or CA 20 can use a different authentication system without departing from the scope of the present inventive subject matter. When the registrant's name, identification information or other like ID is recorded in a registry and/or DB 22, the corresponding authentication certificate 30 is provided to the registrant 10 to permit SMS message sender authentication to be performed. Optionally, the certificate 30 can be based on any public key infrastructure scheme, e.g., like X.509 defined by the ITU-T (i.e., the International Telecommunication Union—Telecommunication Standardization Sector). If an X.509 certificate is used for the authentication certificate 30 provided to the registrant 10, in one embodiment the initial steps of SMS message sender registration and/or recipient device provisioning may optionally be carried out as described below.

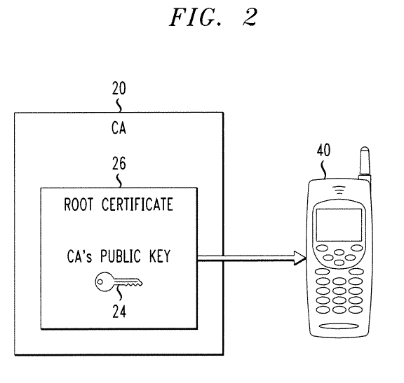

With reference now additionally to FIG. 2, suitably, each CA 20 publishes its public key 24 in its root certificate 26. As will be described later herein, the CA's public key 24 is used to verify the authentication certificates 30 issued by the CA 20, accordingly the root certificate 26 and/or the CA's public key 24 is imported into or otherwise provisioned on each SMS-enabled recipient device 40 that will perform the SMS authentication using authentication certificates 30 issued by the CA 20 in question. While for simplicity and clarity only one SMS-enabled recipient device 40 is illustrated and/or discussed in the examples and/or embodiments presented herein, it is to be appreciated that in practice generally any number (i.e., one or more) of SMS-enabled recipient devices may be similarly situated and/or equipped.

Suitably, vendors of SMS-enabled recipient devices may optionally pre-load the root certificates and/or CA public keys of interest (e.g., including those of any local regional registries, popular trade and professional registries, etc.) in much the same way that web browsers are pre-loaded with PKI (Public Key Infrastructure) certificates. Alternately or in addition, as show in FIG. 2, an end-user may also import or otherwise load one or more root certificates and/or CA public keys (e.g., such as the root certificate 26 and/or public key 24 of the CA 20) onto their SMS-enabled recipient device 40 as desired, e.g., in the cases where the end-user does business in multiple regions or is interested in one or more specialized registry. As understood by those skilled in the art, there is generally no limit to how many root certificates and/or public keys can be imported or provisioned on the SMS-enabled recipient device 40 of an end-user.

Suitably, as shown, the SMS-enabled recipient device 40 is implemented as a wireless or mobile telephone or other like CPE. Alternately, the recipient device 40 may be any other SMS-enabled device.

Returning attention now to FIG. 1, in accordance with one exemplary embodiment, each applicant (i.e., SMS message sender) wishing to become a registrant 10, generates its own public/private key pair (i.e., 12 and 14 respectively), and submits their public key 12 to the respective CA 20 along with their name, identification information and/or other like ID, and any other appropriate registration information and/or documentation. Thereafter, if the respective CA 20 determines that the applicant in fact owns or is otherwise entitled to register the supplied name, identification information and/or other like ID, then the CA 20 enters the foregoing identification data into its database 22 and uses its private key (i.e., the CA's private key 28) to sign an authentication certificate 30 that includes the registrant's identification data and the registrant's public key 12. In this manner, the respective CA 20 “vouches” that the registrant's public key 12 (i.e., contained in the certificate 30) is in fact the public key 12 that is bound to the registrant's name, identification information and/or other like ID (which is also contained in the certificate 30), and that the registrant 10 is entitled to use this identification data. In turn, the authentication certificate 30 which is signed with the respective CA's private key 28 and which includes the registrant's identification data and the registrant's public key 12 is returned or otherwise provided to registrant 10 (i.e., the SMS sender which will then employ the received authentication certificate 30 for authentication proposes).

As can be appreciated, the registrant 10 now has an authentication certificate 30 (signed and issued by the respective CA 20) that attests to its identification data, and the registrant 10 also has its own private key 14 that permits the registrant 10 to validate that authentication certificate 30.

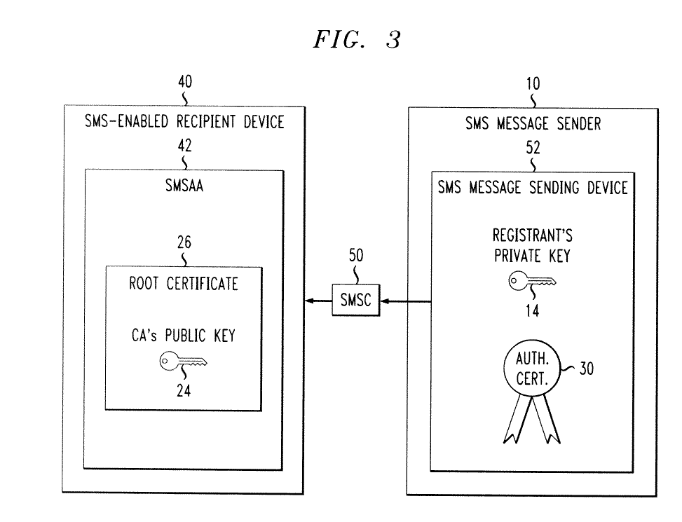

With attention now to FIG. 3, there is shown an embodiment of an SMS message sender authentication arrangement in accordance with aspects of the present inventive subject matter. In the illustrated example, the SMS-enabled recipient device 40 (which has, e.g., as described above, been previously provisioned with the root certificate 26 and/or public key 24 of the CA 20) is shown receiving an SMS message forwarded from an SMSC (SMS Center) 50, the aforementioned message being sent from an SMS sending device 52 which is owned and/or operated, e.g., by an entity (such as the registrant 10) that has previously registered with the CA 20 (e.g., in the manner described above). As shown, the SMS sending device 52 is optionally provisioned with the registrant's authentication certificate 30 that was received from the CA 20 and with the registrant's private key 14. Suitably, the SMS message sending device 52 is a wireless or mobile telephone, a smartphone, a wireless PDA or other like handheld device, a laptop or desktop computer, or other suitable SMS-enabled device or CPE.

Optionally, the SMS-enabled recipient device 40 suitably performs or otherwise controls the authentication of the SMS message sender 10. To this end, the recipient device 40 is equipped and/or otherwise provisioned with a SMS authentication application (SMSAA) 42, which provides for a very secure form of SMS authentication in accordance with aspect of the present inventive subject matter. As can be appreciated, this security stems from the recipient device 40 having direct control and/or oversight of the SMSAA 42, meaning that the end-user of the SMS-enabled recipient device 40 has only to trust their own device. Of course, however, in other alternate embodiments, it is possible to have a trusted proxy perform the authentication. But, such an arrangement may open up avenues of attack and/or make suitably trustworthy authentication more difficult to make secure.

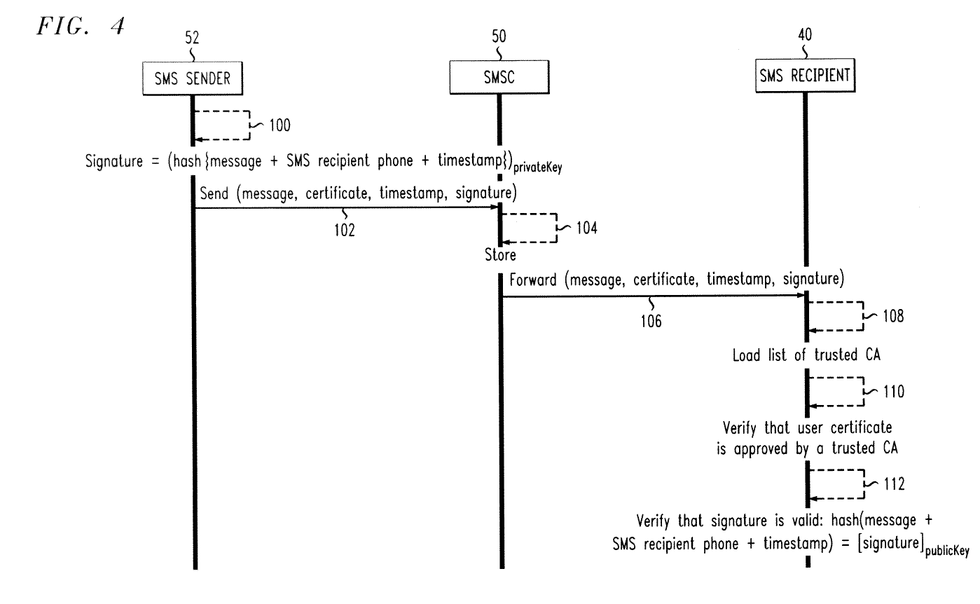

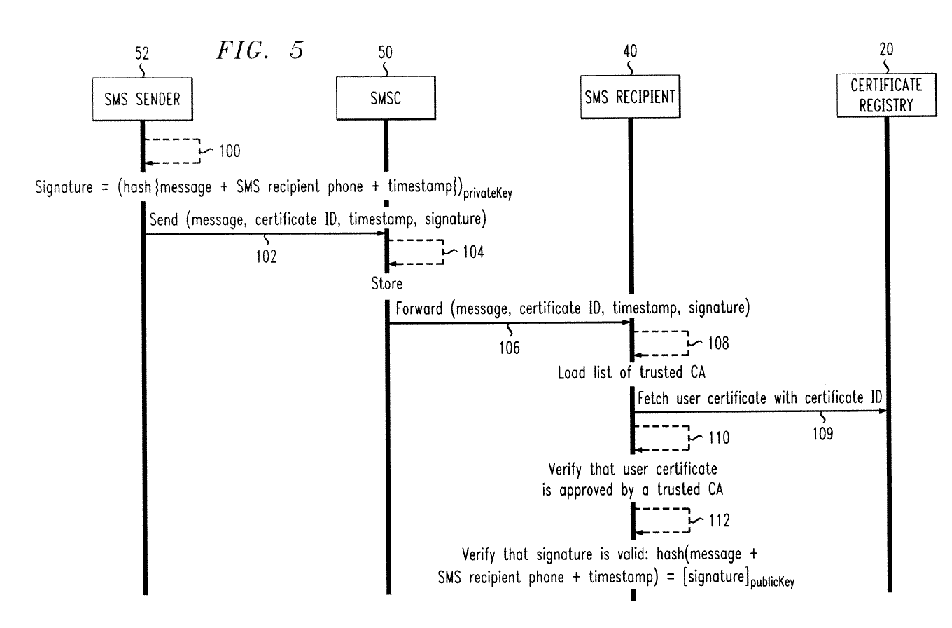

In general terms, FIG. 4 shows, in accordance with one exemplary embodiment, a basic view of authentication-related tasks and message flows between two SMS-enabled devices (such as devices 52 and 40) and the SMSC 50. Note for the sake of simplicity, intermediate mobile equipment (e.g., such as the SGSN (Serving GPRS (General Packet Radio Services) Support Node) at the mobile access premise) and/or other like intermediate equipment has been omitted in FIGS. 4 and 5.

In any event, the first step is for the SMS sender (i.e., device 52) to generate a digital signature based on the private key (i.e., key 14) associated with the sender's authentication certificate (i.e., certificate 30), and the message to be sent, along with additional session information such as a timestamp and/or the sender's and/or recipient's telephone number or other like ID or address, e.g., to guard against replay type of attacks. Upon reception of the authenticated SMS, the SMSC 50 stores both the message and the authentication credentials, until the SMS recipient becomes available to retrieve the message. The SMSC 50 will then forward the authenticated SMS message to the final destination (i.e., the recipient device 40). Finally, the SMS message recipient 40 checks the validity of the credentials attached to the SMS message, e.g., with the following steps: (1) the validity of the certificate 30 is established and/or checked to see that it is signed by a trusted CA (i.e., from the recipient's trusted CA list); (2) the recipient computes a digest of the message concatenated with a timestamp and the recipient's telephone number or other like address (e.g., to guard against replay attacks); and (3) the authentication is deemed successful if step (1) is met and if the digest computed in step (2) matches the decryption of the signature, using the public key (i.e., key 12) attached to the certificate (i.e., certificate 30).

With reference now to FIG. 4, there is shown an exemplary SMS message sender authentication process in accordance with aspects of the present inventive subject matter. In the present example, authentication credentials, e.g., including a digital signature and X.509 certificate, are sent along with the message. Traditionally, SMS message are limited to 160 bytes, and in some cases, this may be too short to include the authentication credentials. However, concatenated SMS (as is known in the art) provides a viable alternative, with a reassembling technique allowing the communication of SMS messages spanning up to 255 times 160 bytes, or 41 KB. In any event, it has been determined that the size of an X.509 certificate using 1024 bit keys (e.g., such as RSA keys) and embedding an image of size 1068 bytes is 1684 bytes. Thus, using the concatenation technique (1684 bytes is about 11×160 bytes), there is ample room to carry the authentication credentials and the SMS message itself (up to approximately 39 KB). Alternately, the devices could be provisioned with different certificates holding different key lengths, thereby reducing the size of the resulting certificate. Indeed, depending on the usage, a low security level may be appropriate. Alternately or in conjunction, the certificate could hold a reduced image size (or no image at all), thereby further streamlining the overall certificate size.

In any event, as shown in FIG. 4, the process starts at step 100 with the SMS message sending device 52 producing a signature. For example, the device 52 generates a digital signature and digitally signs the authentication certificate 30 with which it is provisioned, e.g., by the registered certificate owner. As shown, the signature is a hash of the SMS message being sent, the SMS recipient's phone number or other like address, and a timestamp, encrypted with the private key 14 of the registrant 10 (i.e., the previously registered SMS message sender 10 operating the device 52 to send the SMS message in question).

At step 102, the SMS message sending device 52 send the SMS message to the SMSC 50. As shown, message sent by the device 52 includes the SMS message itself, the sender's authentication certificate 30, a timestamp, and the signature from step 100.

At step 104, the SMSC 50 stores the message and authentication credentials received from the sending device 52 until the recipient device 40 is available to retrieve the message.

At step 106, when the recipient device 40 is available to retrieve the message, the SMSC 50 forwards the SMS message and accompanying authentication credentials to the recipient device 40.

At step 108, upon receiving the forwarded message and accompanying credentials, the recipient device 40 loads a list of trusted CAs. Suitably, in this example, the list may include the CA 20. By loading the list, the client 40 now has access to the public keys of each CA in the loaded list. Accordingly, if the client 40 has previously been provisioned with the public key 24 of the CA 20, then that public key 24 is now made available for decryption and/or authentication purposes.

At step 110, the client 40 verifies that the certificate 30 received along with the message is in fact approved by a trusted CA or otherwise authentic. In particular, using the public key 24 of the CA 20 (e.g., with which the recipient device 40 was previously provisioned), the certificate 30 included with the message (e.g., which was previously encrypted with the CA's private key 28 when the certificate 30 was issued) is now able to be decrypted to reveal the identification data contained in the certificate 30 and the public key 12 of the registrant 10 which is bound to the identification data in the certificate 30. In this way, the recipient device 40 obtains the identification data contained in the received certificate 30 and the registrant's public key 12 which is also contained in the received certificate 30. Moreover, insomuch as the CA's public key 24 works to unlock or decrypt the certificate 30, the recipient is assured that the certificate 30 was in fact encrypted with the CA's private key 28 when the certificate 30 was issued, and accordingly, the identification data and registrant's public key 12 contained therein are therefore authentic.

At step 112, the recipient device 40 then verifies the signature received along with the SMS message. Suitably, this is accomplished using the public key 12 recovered in step 110 from the certificate 30 included with the SMS message. In particular, the public key 12 recovered from the certificate 30 is used to decrypt the signature received in the certificate reply message, i.e., thereby revealing the hash of the message, the recipient's telephone number or other like address and the timestamp. In this manner, insomuch as the public key 12 recovered from the received certificate 30 works to unlock or decrypt the received signature to reveal the same hash or hash elements as were used in step 100, the recipient is assured that the signature was encrypted with the registrant's corresponding private key 14, and accordingly, the signature is authentic.

Depending on the available storage at the SMSC 50 and/or the willingness of the SMS provider to change its pricing model (e.g., so as not to result in unreasonable costs to the end-user for extra messages that may be sent in accordance with the above authentication scheme using concatenated SMS), it may be advantageous to proceed in a slightly different manner. This is the object of a second embodiment, e.g., illustrated in FIG. 5. In this case, the system and/or method employs a reference or certificate ID that points to the location of actual certificate 30. Accordingly, one is able to conserve room by sending the certificate ID along with the SMS message instead of the certificate 30 itself. Notably, the digital signature itself will generally only be few bytes long, e.g., 64 bytes. Suitably, the certificate ID is a unique reference in a database, or simply a URL (Uniform Resource Locator) pointing to the certificate. In general, it is expect that the whole signature including certificate ID can be handled with less than 100 bytes, which leaves the message sender more than 60 bytes for the message itself. In most cases, this should be enough, and if not, extra messages could still be sent using the concatenation technique.

As sown in FIG. 5, the process for the second embodiment is essentially the same as shown in FIG. 4 with a few exceptions. Accordingly, similar steps are number alike. However, as noted above, the certificate 30 is not sent along with the message, rather a certificate ID which points to the location of the certificate 30 is sent instead. Accordingly, prior to step 110, the recipient device 40 uses the certificate ID in step 109 to fetch the actual certificate from the location to which the certificate ID points. In one suitable example, the actual certificate 30 may be fetched from the certificate registry or CA 20.

Note that in both of the above embodiments illustrated in FIGS. 4 and 5, respectively, optionally the SMS sending device 52 is provisioned with an on-demand authentication feature that the SMS message sender may selectively activate before sending their message. Thus, the sender can have control over which messages should be authenticated Note also that fetching the certificate 30 (as illustrated in the embodiment of FIG. 5) generally means that the recipient device 40 has to have access to both the certificate ID and access to a certificate registry. In this latter embodiment, repetitive access to the registry could impact the overall authentication process response time. Accordingly, in this case, it is optional to implement a caching mechanism that would store the certificate 30 on the recipient device 40 for future re-use as warranted. Additionally, once the sender's certificate is obtained either by fetching it from the registry or by parsing it directly through the SMS message, and the verification process is completed, the authentication status may optionally be displayed on or otherwise output from the recipient device 40.

Finally, in yet another alternate embodiment, the SMS messages may optionally be authenticated prior to actually retrieving the whole message. The advantage of performing authentication first is that unwanted message retrieval may be avoided, e.g., when a message authentication fails. However, such an embodiment generally involves additional changes to standard SMS messaging systems and/or methods. For example, in this alternate embodiment authentication credentials may be explicitly stored (i.e., not blended with the message) on the SMSC gateway, and a specific authentication credentials retrieval protocol is defined between the gateway and recipient device 40 to negotiate forwarding and/or processing of the credentials.

In conclusion, it is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. In a telecommunications network, a method for authenticating a sender of a message to a recipient of the message, said method comprising:
(a) registering the sender with a trusted certificate authority (CA), said registering including providing the CA with (i) identification information identifying the sender and (ii) a public key of the sender;
(b) creating an authentication certificate including the sender's identification information and the sender's public key;
(c) signing the certificate with a private key of the CA;
(d) provisioning a message sending device of the sender with the certificate that was signed with the private key of the CA;
(e) provisioning a message receiving device of the recipient with a public key of the CA, said CA's public key being a corresponding counterpart to the CA's private key;
(f) generating a signature with a private key of the sender, said sender's private key being a corresponding counterpart for the sender's public key;
(g) sending a message from sender's message sending device, said message including the certificate and the signature;
(h) retrieving the message with the recipient's message receiving device;
(i) using the CA's public key with which the recipient's receiving device was provisioned to obtain the sender's public key from the certificate received in the retrieved message; and,
(j) using the sender's public key obtained from the certificate received in the retrieved message to verify the signature generated with the sender's private key.

2. The method of claim 1, wherein the message is one of an SMS message, an MMS message or an EMS message.

3. The method of claim 2, wherein the message sent in step (g) further includes a recipient identifier, said recipient identifier being one of a telephone number or an address for the recipient.

4. The method of claim 3, wherein the message sent in step (g) further includes a timestamp.

5. The method of claim 4, wherein the generated signature is a hash of the message being sent, the recipient identifier and the timestamp encrypted by the sender's private key.

6. The method of claim 5, wherein the recipient's message receiving device is provisioned with a plurality of public keys from a plurality of trusted CA's, and prior to step (i) a list of trusted CAs are loaded in the recipient's message receiving device, and the recipient's message receiving device uses the corresponding public keys of the respective CAs to verify that the certificate received with the message is approved by at least one trusted CA in the loaded list.

7. In a telecommunications network, a method for authenticating a sender of a message to a recipient of the message, said method comprising:
(a) registering the sender with a trusted certificate authority (CA), said registering including providing the CA with (i) identification information identifying the sender and (ii) a public key of the sender;
(b) creating an authentication certificate including the sender's identification information and the sender's public key;
(c) signing the certificate with a private key of the CA;
(d) provisioning a message receiving device of the recipient with a public key of the CA, said CA's public key being a corresponding counterpart to the CA's private key;
(e) generating a signature with a private key of the sender, said sender's private key being a corresponding counterpart for the sender's public key;
(f) sending a message from a message sending device of the sender, said message including the signature and a pointer that indicates a location where the certificate is stored;
(g) retrieving the message with the recipient's message receiving device;
(h) fetching the certificate with the recipient's message receiving device from the location indicated by the pointer;
(i) using the CA's public key with which the recipient's receiving device was provisioned to obtain the sender's public key from the certificate received in the retrieved message; and,
(j) using the sender's public key obtained from the certificate received in the retrieved message to verify the signature generated with the sender's private key.

8. The method of claim 7, wherein the message is one of an SMS message, an MMS message or an EMS message.

9. The method of claim 8, wherein the message sent in step (g) further includes a recipient identifier, said recipient identifier being one of a telephone number or an address for the recipient.

10. The method of claim 9, wherein the message sent in step (g) further includes a timestamp.

11. The method of claim 10, wherein the generated signature is a hash of the message being sent, the recipient identifier and the timestamp encrypted by the sender's private key.

12. The method of claim 11, wherein the recipient's message receiving device is provisioned with a plurality of public keys from a plurality of trusted CA's, and prior to step (i) a list of trusted CAs are loaded in the recipient's message receiving device, and the recipient's message receiving device uses the corresponding public keys of the respective CAs to verify that the certificate received with the message is approved by at least one trusted CA in the loaded list.

13. In a telecommunications network, a system for authenticating a sender of a message to a recipient of the message, said system comprising:
registering means for registering the sender with a trusted certificate authority (CA), said registering including providing the CA with (i) identification information identifying the sender and (ii) a public key of the sender;
certificate creation means for creating an authentication certificate including the sender's identification information and the sender's public key, said certificate being signed with a private key of the CA;
message sending means for sending a message from the sender, said message sending means being provisioned with the certificate that was signed with the private key of the CA and signature generating means for generating a signature with a private key of the sender, said sender's private key being a corresponding counterpart for the sender's public key, wherein a message sent from sender's message sending device includes the certificate and the signature; and,
message receiving means for retrieving a message sent to the recipient from the sender, said message receiving means being provisioned with a public key of the CA, said CA's public key being a corresponding counterpart to the CA's private key;
wherein the message receiving means: (i) uses the CA's public key with which it is provisioned to obtain the sender's public key from the certificate received in the retrieved message, and (ii) uses the sender's public key obtained from the certificate received in the retrieved message to verify the signature generated with the sender's private key.

14. The system of claim 13, wherein the message is one of an SMS message, an MMS message or an EMS message.

15. The system of claim 14, wherein the message sent by the message sending means further includes a recipient identifier, said recipient identifier being one of a telephone number or an address for the recipient.

16. The system of claim 15, wherein the message sent by the message sending means further includes a timestamp.

17. The system of claim 16, wherein the generated signature is a hash of the message being sent, the recipient identifier and the timestamp encrypted by the sender's private key.

18. The system of claim 17, wherein the recipient's message receiving means is provisioned with a plurality of public keys from a plurality of trusted CA's, and prior to step (i) a list of trusted CAs are loaded in the recipient's message receiving means, and the recipient's message receiving means uses the corresponding public keys of the respective CAs to verify that the certificate received with the message is approved by at least one trusted CA in the loaded list.
